(19) United States
(12) Patent Application Publication
(10) Pub. No.: US 2006/0000305 A1
(43) Pub. Date: Jan. 5, 2006

(54) Adaptive hand control for learning driving skills, therapy, and game playing

(76) Inventor: Stan Everett Payne, Glendale, AZ (US)

Correspondence Address: Stan Payne, 4614 W. Softwind Dr., Glendale, AZ, 85310, US

(21) Appl. No.: 10/872,800

(22) Filed: Jun. 21, 2004

(51) Int. Cl. B60K 20/00

(52) U.S. Cl. 74/473.1

(57) ABSTRACT

The present invention provides a cost-effective device that emulates the operation of the actual vehicle assist devices and interfaces with both consumer computer game software for high fidelity on-road traffic simulation and consumer game controller with its standard television display connected to a consumer force feedback steering wheel controller. The invention which emulates the actual vehicle hand controls replaces the standard game type brake and accelerator pedals. The use of a invention for accelerator and brake while game playing allows handicapped people to learn how to operate the device that they will eventually use in a real vehicle or assist in improving upon the neuromuscular skills that they currently use while driving a handicapped adapted vehicle. This device will facilitate safer and more effective training by driver's instructors for the handicapped individual before they have to face a real-world driving scenario and provide enhanced recreational opportunities.

### CROSS-REFERENCE TO RELATED APPLICATIONS

Not applicable

### STATEMENT REGARDING FEDERALLY SPONSORED APPLICATIONS

Not applicable

### REFERENCE TO SEQUENCE LISTING

Not applicable

### BACKGROUND OF THE INVENTION

The present invention relates to hand control devices for the brake and accelerator function as a training platform when the handicapped person is learning or making preparation to learn to drive a real automobile, thus allowing them to learn the skills in a non-threatening simulation environment instead of on the streets.

### BRIEF SUMMARY OF THE INVENTION

This invention is a training device. It is a realistic hand control that mimics the hand controls in a real vehicle adapted for operation by handicapped individuals. It combines this invention of a hand-control training device with autoracing gaming technology that employs a steering wheel. These operate in conjunction with console-based video gaming products such as, but not limited to the following: PS2 “PlayStation2” from Sony, “XBOX” from Microsoft, and “GameCube” from Nintendo. These items listed above interface with an existing television monitor. Additionally, this invention of a hand-control training device will operate with auto racing games played on a PC (personal computer). Currently the existing steering wheels sold to play these games come with a set of pedals that function as the accelerator and brake. These pedals move potentiometers that provide a change in voltage level to the computer/game controller. No prior Art addresses the need of the handicapped community where individuals do not have the use of their legs or feet so as to allow them to use the out-of-the-box pedal technology. Most handicapped people who operate a real automobile use a hand control for the accelerator and brake. This hand control in a real car replaces the foot-operated accelerator and brake devices, because the handicapped person cannot use them. In the same way this hand control device replaces the foot pedals that are provided with game steering wheels. This device also can function as a training platform when the handicapped person is learning or making preparation to learn to drive a real automobile, thus allowing them to learn the skills in a non-threatening simulation environment instead of on the streets. By effectively using this device in a rehabilitation setting, essential finger, hand, and upper body functions will be improved while allowing the patient to engage In an entertaining game.

### BRIEF DESCRIPTION OF THE DRAWINGS

FIG. 1 is a perspective overview of the major components that make up the simulation system. The handicapped acceleration and braking device, the steering wheel, the game console or PC, the TV or PC monitor, and the table are shown.

FIG. 2 is a perspective overview of the major components that make up the handicapped acceleration and braking device

FIG. 3 is the side and top perspective of a built-in bottom clamp.

FIG. 4 is the front support base, the accelerator rod, the brake track movement plate.

FIG. 5 shows how the brake rods interact with the electro mechanical potentiometer to achieve the braking action.

FIG. 6 shows how the accelerator rod interacts with the electro mechanical potentiometer to achieve the acceleration action.

### DETAILED DESCRIPTION OF THE INVENTION

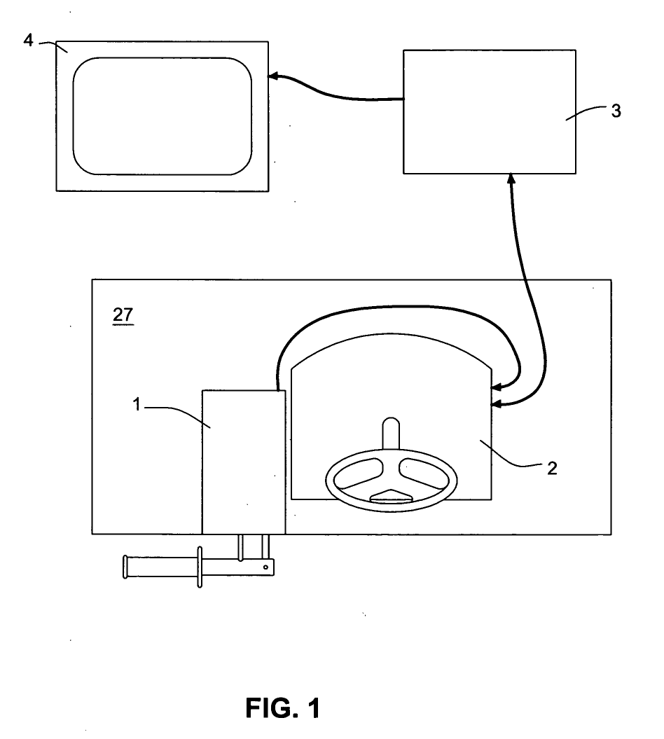

FIG. 1 is the system with all of its major components, the handicapped acceleration and braking device 1, the steering wheel and base 2, the game console or PC 3, the TV or PC monitor 4, and the table or surface area 27, that 1 and 2 are positioned on.

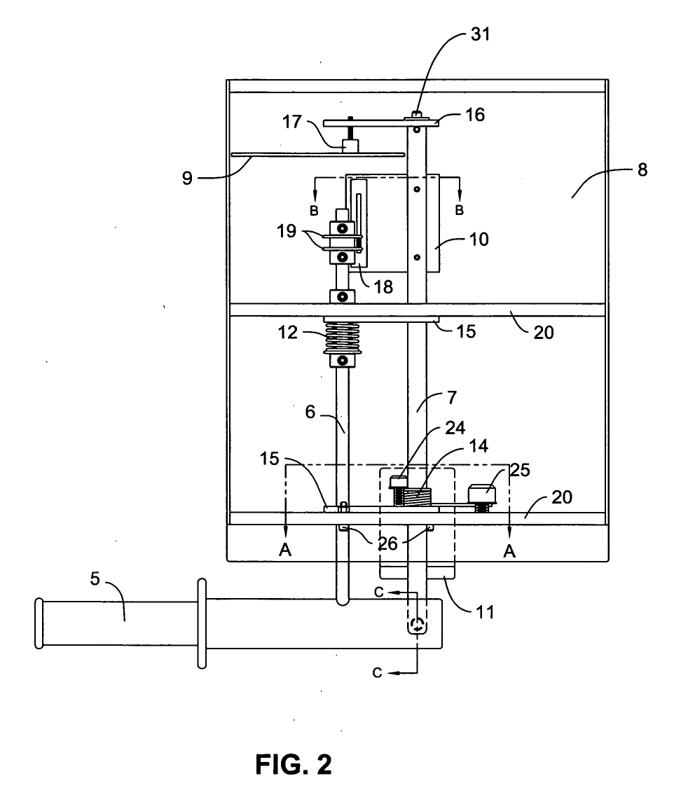

FIG. 2 is the handicapped acceleration and braking device with the hand lever 5, the brake rod 6, the accelerator rod 7, the device base 8, the PCB (Printed Circuit Board) for the accelerator slide potentiometer 9, the PCB (Printed Circuit Board) for the brake slide potentiometer 10, the table clamp 11, the spring to control the brake rod return 12, the spring to control the accelerator rod return 14, the arm that connects the brake to the accelerator 15, the arm that moves the accelerator slide potentiometer 16, the accelerator slide potentiometer 17, the brake slide potentiometer 18, the washers that move the brake potentiometer 19, the vertical support walls 20, the adjustable stops for accelerator rod movement 26, the retaining screws 24 and 25 for the accelerator return spring 14, the retaining bolt 31 for the arm that moves the accelerator potentiometer 17.

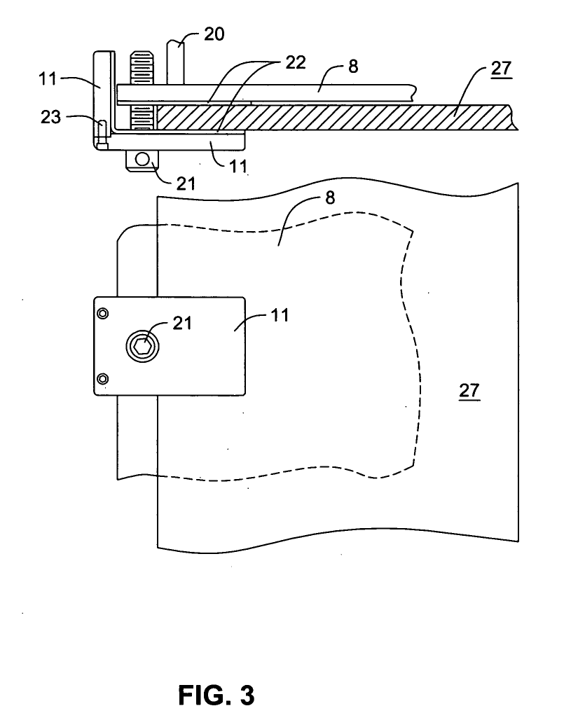

FIG. 3 is the side and top perspective of a built-in bottom clamp 11 and the device base 8 that keeps the base 8 of the device stable while resting on a tabletop 27.

The side perspective shows the front vertical support base 20 and two rubber pads 22 located on the clamps 11 and bottom side of the base 8 to affix the base 8 to a mounting surface 27 by tightening a bolt 21 to bring 11 and 8 together to meet the mounting surface 27.

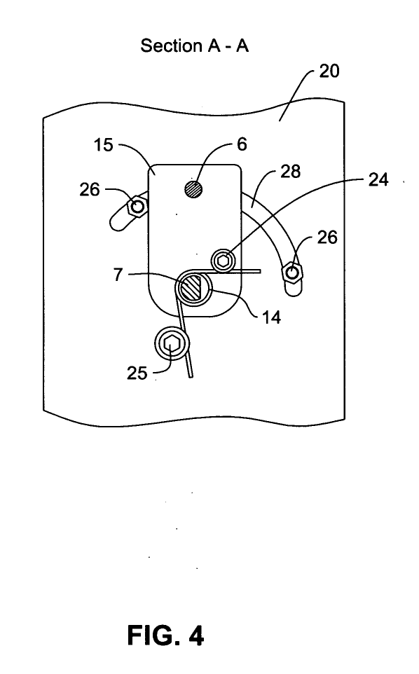

FIG. 4 shows the inside front vertical support base 20, the front allows for the brake rod 6, to move in track 28, between adjustment stops 26, the inside front vertical support 20 of the device where a plate 15 is mounted on the accelerator rod 7 and is forced to rotate with the accelerator rod 7 to the flat on the rod. This plate 15 travels in a predefined course or track 28. The travel is adjusted by 26. The return to neutral position is accomplished by a spring 14 retained by bolts 24 and 25.

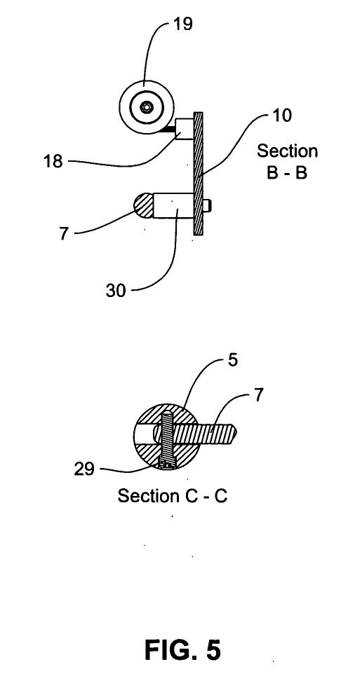

FIG. 5, section view B-B shows how washers 19, mounted on the brake rod and their interaction with the slide potentiometer 18 achieves the braking action for the device. A potentiometer is affixed to a board 10 that travels with accelerator rod 7, via the spacers 30. FIG. 5, section view C-C shows how the accelerator rod 7 is fastened to the handle 5 via the screw 29.

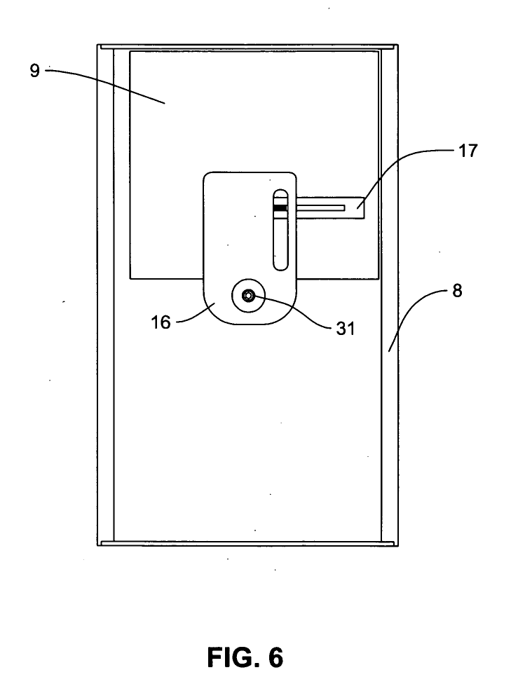

FIG. 6 shows the device base 8 how acceleration and deceleration is achieved with the PCB (Printed Circuit Board) 9 that supports the slide potentiometer 17 and achieves the acceleration action to the device from the change in accelerator rod which rotates plate 16 resulting in the change in wiper position on potentiometer 17. The bolt 31 attaches the arm that moves the accelerator potentiometer 17 to the accelerator rod.

In operation one uses the handle which functions as a lever arm (FIG. 2 item 5) that activates two rods (FIG. 2 items 6 and 7), all being supported by the device base (FIG. 2 item 8), and anchored by the built clamp (FIG. 3 items 11, 21, and 8). The lever arm can optionally be fitted with adaptor grips to maximize the lever handle and human hand interaction. The device base and lever arm can be right-side mounted to be used by the right hand and arm and actuated by the human right-side upper extremity, or left-side mounted to be used by the left hand and arm and actuated by the human left-side upper extremity. When the lever is pulled in a downward vertical motion with the left (right) hand, acceleration is applied to the automobile in the video game via the arm (FIG. 2 item 16) that moves the accelerator potentiometer (FIG. 2 item 17) and its interaction with the potentiometer (FIG. 2 item 17). The farther the lever is pushed down, the greater the acceleration. When the downward pressure is released or lessened, the automobile acceleration in the game lessens, or if completely released, it returns to the neutral position via the function of the return spring (FIG. 2 item 14) and acceleration ceases. This process mimics the use of a handicap adaptive lever for acceleration in an actual automobile. The neutral position is the horizontal plane. When the lever is pushed in a forward motion on the horizontal plane with the left (right hand), the brake is applied to the automobile in the video game via the brake control (FIG. 2 item 19) that moves the brake potentiometer (FIG. 2 item 18), which in turn causes the automobile in the video game to decelerate. The further the lever is pushed in, the greater the deceleration. Conversely, when the forward pressure is released or lessened, the automobile braking lessens or if completely released it returns to the neutral position and braking ceases via the function of the return spring (FIG. 2 item 12). The lever can also be pushed forward on the horizontal plane for braking and pulled in a downward vertical motion for acceleration at the same time resulting in both braking, and acceleration. With said device, a person with leg or foot dysfunction can play a video game using the adaptive game hand control for acceleration and braking.

1. A method of training a person to drive a vehicle having a steering and speed control fitted for the handicapped person, the method including the following steps,
providing a video game console, providing a steering wheel to output steering information to the console,
providing an acceleration and braking simulation device that is able to simulate the feel and action of the actual acceleration and braking device for a vehicle fitted for the handicapped person and to output acceleration and braking information to the console,
providing an acceleration and braking simulation device with interchangeable grips fitted for the handicapped person's unique accommodation requirements, connecting the output of the steering wheel and the acceleration and braking simulation device to the video game console,
connecting the video game console to a television or monitor,
operating the steering wheel and the acceleration and braking simulation device to practice the motions necessary to drive a vehicle having a steering and speed control fitted for the handicapped person,
and operating the acceleration and braking simulation device with interchangeable grips.
